(19) United States
(12) Patent Application Publication
(10) Pub. No.: US 2016/0253723 A1
(43) Pub. Date: Sep. 1, 2016

(54) PAPER CALCULATION SYSTEMS AND METHODS

(71) Applicant: William Fischer, Orange, CA (US)

(72) Inventor: William Fischer, Orange, CA (US)

(73) Assignee: Fisher Printing, Inc., Orange, CA (US)

(21) Appl. No.: 15/152,364

(22) Filed: May 11, 2016

Related U.S. Application Data
(63) Continuation of application No. 13/186,023, filed on Jul. 19, 2011.

(51) Int. Cl. G06Q 30/06; G06Q 30/02

(52) U.S. Cl. CPC G06Q 30/0611; G06Q 30/0283; G06Q 30/0641

(57) ABSTRACT

A system and method to provide a price calculation for e-commerce related sales by utilizing a plurality of paper characteristics to determine final prices. The present invention utilizes at least four inputs including paper type, width, length and sheets to return to potential online e-commerce users a price calculation for a particular order. Additionally, the system may allow the individual user to select paper type, length and sheets, then utilizes a multiplication factor which is stored in a remote database which calculates a MWT value and returns to the user the final price calculated for their particular order.

### PRIORITY CLAIM

This continuation application claims priority to the earlier filed U.S. patent application Ser. No. 13/186,023 filed on Jul. 19, 2011 and U.S. Provisional Application No. 61/365,700 filed on Jul. 19, 2010, entitled “Paper Calculation Process and Methods.”

### FIELD OF THE INVENTION

The field of the invention generally relates to determining a price for a quantity of paper. More specifically, the field of invention generally relates to utilizing a plurality of search characteristics to estimate costs and fees associated with the ordering of paper and paper-related materials.

### BACKGROUND

The utilization of electronic commerce methodology and systems have made electronic sales a much more efficient and easy way of conducting business. Electronic commerce systems for selling everything from books to real estate have become increasingly available. However, developing back-end transaction processing systems has required considerable skill and time invested in custom programming to meet the needs of the e-commerce provider. Development time can slow the entry of a new e-commerce provider to market. Typically, sufficient time and effort must be taken to develop the e-commerce website, pricing structure and sales checkout menu system to effectuate a properly working e-commerce site. Additionally, sufficient back-end platform development is needed for many different e-commerce functions including billing, pricing, accounting, customer care, and collection for allowing the providers to apply their own business rules without having to do expensive in-house or contracted programming to conduct the sale.

There are a variety of systems that have been developed to help the e-commerce merchants conduct business without sufficient programming experience and/or interaction with the website. These systems have been generated to help in certain e-commerce sectors including some small and medium-size merchants for a set of platform-independent business components, such as a general ledger. However, a problem that exists with some of these systems is that they tend to be complex and only offer specific services that may not be beneficial to some industries and/or markets. Additionally, the complexity of these systems make their uses very minimal in some cases and causes undue hardships in navigating through the system and implementing only the desired functionality of a “one size fits all” e-commerce system.

Moreover, the traditional prior art systems presently employed must be customized for each new service provided. There is no readily available generic back-end e-commerce software that allows for adaptability and customization after it is purchased from the vendor. Complex products are also found in the online music and publishing realms, where online distributors agree to pay a royalty on each unit sale, license, or rental, which is commonly (but not always) determined as a fixed fee or a percent of the overall price of the unit.

Typically, trying to price complex products and services requires sensitivity to a plurality of navigational articles. In the most sophisticated examples, separate tax and discount/premium treatments are applied to each price component of a complex product. The challenge is not only to calculate the customer prices of such complex products or services, but to engage an automated system of accounting that represents this complexity, and allows for periodic reporting and auditing of the price components.

Prior art price calculation systems have been utilized for a while. For example, there are tracking programs that allow for pricing of online purchases of many different systems including software, hardware and the like.

The growing market for complex products and services delivered online demands that an efficient generic back-end system be provided which allows the flexibility and ease-of-use of a generic back-end system to be married with the sophistication of custom programming for complex product and service providers. Therefore, a need exists in the paper community to have a dynamic pricing system which allows the purchaser to utilize a website and order paper which will give an estimated and calculated costs based on a plurality of paper characteristic information.

### SUMMARY OF THE INVENTION

### I. Terminology

In the following description, certain terminology is used to describe features of the invention. For example, the term “computerized” generally represents that any corresponding operations are conducted by hardware in combination with software and/or firmware.

In certain situations, both terms “logic” and “engine” are representative of hardware, firmware and/or software that is configured to perform one or more functions. As hardware, logic (or engine) may include circuitry having data processing or storage functionality. Examples of such circuitry may include, but are not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Logic (or engine) may be software in the form of one or more software modules, such as executable code in the form of an executable application, an application programming interface (API), a subroutine, a function, a procedure, an applet, a servlet, a routine, source code, object code, a shared library/dynamic load library, or one or more instructions. These software modules may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code is stored in persistent storage.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Embodiments of the disclosure employ a system and method to provide a price calculation for e-commerce related sales by utilizing a plurality of paper characteristics to determine one or more prices. In one embodiment, at least four characteristics are input to the system, including by way of non-limiting example, paper type, width, length and sheets so as to determine a price for a particular order. Additionally, in one embodiment the system may allow a user to select paper type, length and sheets, wherein a multiplication factor is used determine a MWT value and return a price calculated for the user's particular order.

In one embodiment, it is contemplated that the system provides a price calculation system for e-commerce applications.

In one embodiment, it is contemplated that the system utilizes a plurality of characteristics so as to provide a price calculation.

In one embodiment, a system for automated price quote generation, the system comprising: a processor; and a memory, coupled to the processor and including instruction causing the processor to perform the following steps: establish a database in memory; store information concerning a plurality of available paper characteristics in the database, the stored information including information regarding a plurality of features associated with each paper characteristic; and generating a price quote for each available paper type in the search results, the price quote calculated based on a predefined pricing rule associated with the paper type.

In another exemplary embodiment, a paper sorting machine coupled to the processor and wherein the memory further includes instructions causing the processor to: process an order based on the quote; and send signals to the paper sorting machine causing the paper sorting machine to select the paper for the order.

In another exemplary embodiment, a paper cutter coupled to the processor and wherein the memory further includes instructions causing the processor to: process an order based on the quote; and send signals to the paper cutter for cutting the paper based on a selection of paper characteristics from the plurality of available paper characteristics in the database.

In another exemplary embodiment, wherein a specification of the paper used to generate the price quote is selected from the group comprising a paper type, paper width, paper length, and number of sheets; and further including instructions causing the processor to utilize a multiplication factor which is stored in a remote database which calculates a MWT value and returns to the user the final price calculated for their particular order.

In another exemplary embodiment, wherein the predefined pricing rule adjusts the calculation of the price quote based on the specification.

In another exemplary embodiment, wherein the predefined pricing rule adjusts the calculation of the price quote based on information specific to the paper type.

In another exemplary embodiment, wherein the predefined pricing rule is further associated with a specified paper weight.

In another exemplary embodiment, comprising a plurality of graphical tools to facilitate interfaces between an internet user and the online e-commerce site is provided.

In another exemplary embodiment, further comprising instructions causing the processor to a selected paper type is input, a width and a length of the selected paper type are multiplied and result in an MWT value whereby a fourth input is multiplied to determine a total weight.

In another exemplary embodiment, wherein, after determining total weight, a price break is obtained from the database and the final price is calculated.

In an exemplary embodiment, a method for automated price quote generation comprising: establish a database in memory; store information concerning a plurality of available paper characteristics in the database, the stored information including information regarding a plurality of features associated with each paper characteristic; and generating a price quote for each available paper type in the search results, the price quote calculated based on a predefined pricing rule associated with the paper type.

In another exemplary embodiment, comprising sending signals to a paper sorting machine causing the paper sorting machine to select the paper for the order.

In another exemplary embodiment, comprising: processing an order based on the quote; and sending signals to a paper cutter for cutting the paper based on a selection of paper characteristics from the plurality of available paper characteristics in the database.

In another exemplary embodiment, wherein a specification of the paper used to generate the price quote is selected from the group comprising a paper type, paper width, paper length, and number of sheets; and further including using a multiplication factor which is stored in a remote database to calculate a MWT value and returning the final price calculated for their particular order to the user.

In another exemplary embodiment, comprising using the predefined pricing rule to adjust the calculation of the price quote based on the specification.

In another exemplary embodiment, comprising using the predefined pricing rule to adjusts the calculation of the price quote based on information specific to the paper type.

In another exemplary embodiment, wherein the predefined pricing rule is further associated with a specified paper weight.

In another exemplary embodiment, comprising using a plurality of graphical tools to facilitate interfaces between an internet user and the online e-commerce site is provided.

In another exemplary embodiment, comprising instructions causing the processor to a selected paper type is input, a width and a length of the selected paper type are multiplied and result in an MWT value whereby a fourth input is multiplied to determine a total weight; and wherein, after determining total weight, a price break is obtained from the database and the final price is calculated.

In an exemplary embodiment, a computer readable media storing instructions for a method for automated price quote generation, the method comprising: establish a database in memory; store information concerning a plurality of available paper characteristic in the database, the stored information including information regarding a plurality of features associated with each paper characteristics; and generating a price quote for each available paper type in the search results, the price quote calculated based on a predefined pricing rule associated with the paper type.

In yet another exemplary embodiment, a plurality of graphical tools to facilitate interfaces between an internet user and the online e-commerce site is provided.

Still another exemplary embodiment is to provide a system and method to calculate paper pricing and value whereby the system utilized inputs to determine price.

In an exemplary embodiment, a system and method to determine and calculate paper pricing is provided whereby the system utilizes a plurality of inputs whereby at least one input is a paper type.

In yet another exemplary embodiment, a system and method to determine and calculate paper pricing is provided whereby the system utilizes a plurality of inputs whereby at least one input is paper length.

Still another exemplary embodiment a system and method to determine and calculate paper pricing is provided whereby the system utilizes a plurality of inputs whereby at least one input is paper sheets.

Further, an exemplary embodiment, a system and method to determine and calculate paper pricing is provided whereby the system utilizes a plurality of inputs whereby a corresponding multiplication factor may be stored in a remote database.

In still another exemplary embodiment, a system and method to determine and calculate paper pricing is provided whereby the system utilizes a plurality of inputs whereby the plurality of inputs include type, width, length, sheets and further where paper type is selected. The system may bring up a corresponding multiplication factor stored in a remote database.

It is contemplated that a system and method to determine and calculate paper pricing is provided whereby the system utilizes a plurality of inputs whereby at least one input is paper type, whereby after selection of paper type, the width and length are multiplied and result in a MWT value whereby the fourth input is multiplied and the results create the total weight.

It is further contemplated that the system and method to determine and calculate paper pricing is provided whereby the system, after determining total weight and the proper price break (which is obtained from the database) is brought upon and the final price (per thousand sheets) is calculated.

Various objects, features, aspects and advantages of the present invention will become more apparent from the following detailed description of preferred embodiments of the invention, along with the accompanying drawing.

### BRIEF DESCRIPTION OF THE DRAWINGS

FIG. 1 illustrates a flow diagram of an exemplary method in accordance with the systems and methods described herein.

FIG. 2 illustrates an embodiment of a system in an exemplary embodiment of the invention.

FIG. 3 illustrates an example input page for various paper characteristics and features.

### DETAILED DESCRIPTION OF THE PREFERRED EMBODIMENT

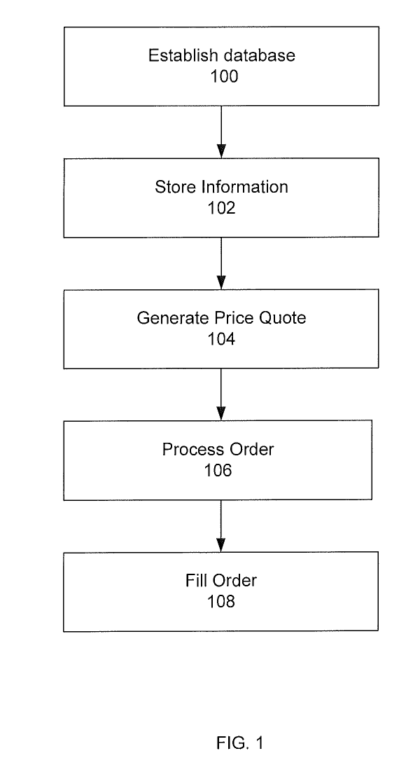

FIG. 1 illustrates a flow diagram of an exemplary method in accordance with the systems and methods described herein. In step 100 a database is established in a memory. The memory may be volatile memory such as random access memory (RAM), including DRAM, SDRAM, SRAM, or other volatile memory types currently being developed or yet to be developed or non-volatile memory such as read only memory (ROM), PROM, EPROM, EEPROM, Flash or other non-volatile memory types currently being developed or yet to be developed.

The memory may also be other types of storage devices such as disk drives, CD-ROM or DVD-ROM drives and the associated media, external memory devices such as “thumb drives,” etc. that may be used to read or write computer data. Additionally, the memory may be an internal device; an external storage device, including a remote device; or some combination of internal, external, and remote storage devices.

In step 102, information may be stored in the database relating to a plurality of paper characteristics. The stored information may include details regarding a plurality of paper characteristic or features associated with the paper. In one embodiment, the paper characteristics and/or features may be stored in a specification of the paper. The characteristics of the specification may include, by way of non-limiting example, paper type, paper width, paper length, and number of sheets as well as other characteristics of the paper such as grade, weight, type, grain, smoothness, color, brightness, reflectance, recycled, percentage recycled, opacity, etc. In one embodiment, one or more paper features may also be stored in the specification, including for example, hole-punched, pre-folded, e.g., table tents, lined/ruled, as well as other features.

In step 104, a price quote is generated for each available paper type in the search results. The price quote can be calculated based on a predefined pricing rule or rules associated with the paper type as well as the paper characteristics, features, or some combination of types, characteristics, or features.

In step 106, if an order is placed, for example, the order can be processed and in step 108 the order can be filled. In some cases, filling the order may involve using a paper cutting machine 210 for cutting the paper based on a selection of paper characteristics from the plurality of available paper characteristics in the database. In many cases, however, paper will be pre-cut and packaged to include all of the desired characteristics, features, etc. In other words, the system will be used in conjunction with pre-packaged inventory. Filling the order can also include using a paper sorting machine 208 or other automated system to select the paper for the order. For example, in an embodiment, the systems and methods described herein may include a robotic device that can retrieve the desired paper from, for example, a warehouse.

In one embodiment, a multiplication factor may be stored in a remote database, and configured so as to be used in an overall price calculation methodology. In one embodiment, an MWT value may be calculated so that a final price may be calculated for a user's particular order. Additionally, a selected paper type may be inputted, including, for example, a width and a length of the selected paper type. In one embodiment, these details be multiplied so as to result in an MWT value. Other inputs may also be multiplied to determine a total weight. After determining total weight, in some embodiments, a price break can be obtained from the database and the final price is calculated.

Some embodiments of the systems and methods described herein may include a plurality of graphical tools to facilitate interfaces between an internet user and the online e-commerce site is provided. For example, a graphical user interface may be used. This interface may include icons that represent one or more paper types, characteristics, and may be implemented as part of a graphical user interface.

In an embodiment, different characteristics may be compiled and filtered as they relate to any of various paper and paper-related products so as to identify products having the desired characteristics. In on embodiment, the selected characteristics will also be used to determine price. It is envisioned that in certain instances, two or more different brands of paper may have the same characteristics. Accordingly, each brand may be presented to the user for potential purchase. If the brands have different prices for paper with the same characteristics, type, quantity, etc., different multiplying factors may be used to determine the correlated price.

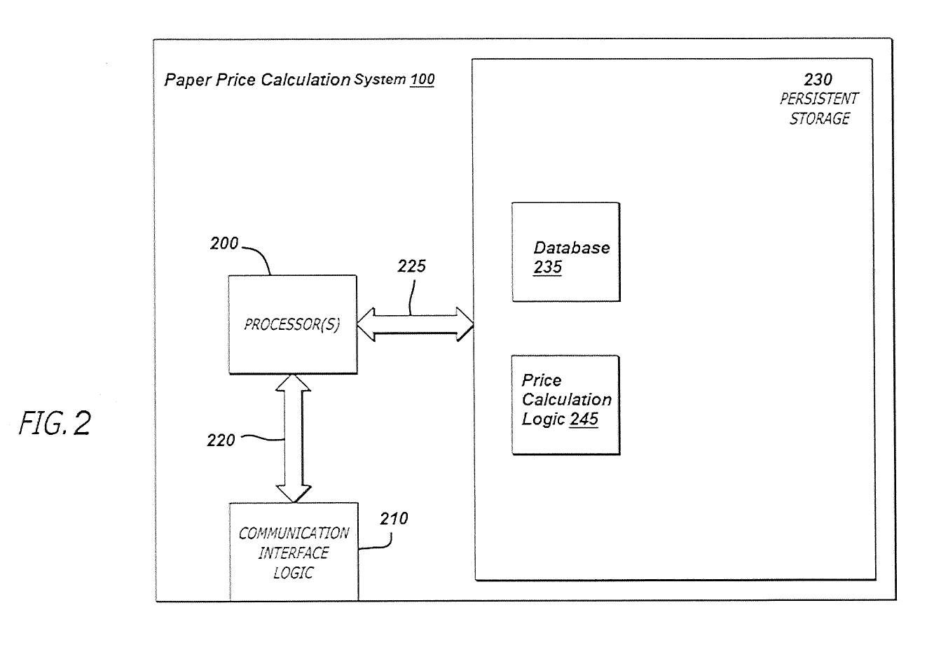

Referring now to FIG. 2 an exemplary block diagram of logic associated with the price calculation systems and methods as discussed with respect to FIG. 1, The paper price calculation system 100 comprises one or more processors 200 that are coupled to the communication interface logic 210 via a first transmission medium 220. According to one embodiment of the disclosure, the communication interface logic 210 may be implemented as a physical interface including one or more ports for wired connectors. Additionally, or in the alternative, communication interface logic 210 may be implemented with one or more radio units for supporting wireless communications with other printing devices.

In one embodiment, price calculation system 200 may feature one or more processor(s) 200 is further coupled to the persistent storage 230 via the transmission medium 225. According to one embodiment of the disclosure, the persistent storage 230 may include a database 235 and price calculation logic 245. In one embodiment, the database 235 is configured to store information concerning a plurality of available paper characteristics in the database, the stored information including information regarding a plurality of features associated with each paper characteristic. In one embodiment, the price calculation logic 245 includes logic configured so as to generate one or more price quotes for each available paper type in the search and/or filtered results. In one embodiment, the price quote is calculated based on a predefined pricing rule associated with the paper type.

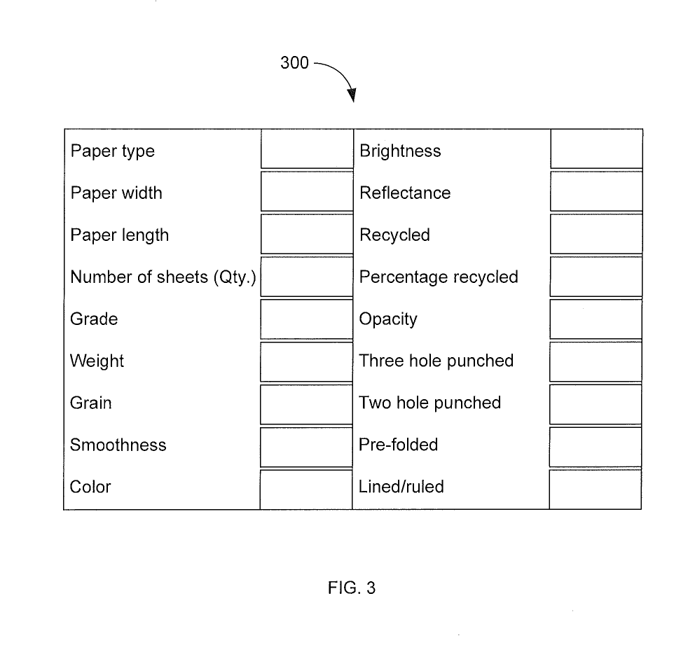

FIG. 3 illustrates an example input page 300 for various paper characteristics and features. In one embodiment, paper type may be entered into one or more input fields. The available stock/inventory may be searched based on parameters that are entered for each of these or other features. Zero, one, or multiple input fields may be made available as part of the price calculation system. Accordingly, in one embodiment, various features may be left blank. Features left blank will not eliminate the paper available. For example, if “8.5” is input for width and “11” is entered for length, and no other features or characteristics are entered, every 8.5 by 11 paper in stock may be displayed to the user. (This example assumes an embodiment that stocks pre-cut paper rather than one that controls a paper cutting device.)

Paper width and paper length may be proved as a number of English or metric units in the corresponding boxes. In one embodiment, a selection may be made between predetermined sizes, lengths, or widths, e.g., using a radio button. In one embodiment, the number of sheets of paper may be entered as a specific number or as predetermined quantities, e.g., 250 sheets, 500 sheets, 1000 sheets, 5000 sheets, etc., using a radio button, or any other graphical representation, without limitation.

It is envisioned that in embodiments, a paper grade and/or weight may be entered using a number or selecting a radio button as well as other attributes of the paper such as type, grain, smoothness, color, brightness, reflectance, recycled, percentage recycled, opacity, etc. In an embodiment, recycled might be an optional characteristic. Paper features such as hole punched or pre-folded might also be selected using text entry (yes, no) or radio buttons. In one embodiment, paper may include a coated stock, wherein the paper has a surface coating that has been applied to make the surface more receptive for the reproduction of text and images so as to achieve sharper detail and improved color density. In one embodiment, paper may include a coated clay pigment, wherein the objective of coating the stock is to improve the smoothness and reduce the absorbency of the paper. In embodiments, filters may be provided so that finishes can be categorized as matte, dull, cast, gloss, and high gloss. It is envisioned that various codes may be utilized for the coatings, e.g., in one embodiment, a user may input “C2” to indicate coating one side, or indicate “C1” to indicate one side only.

As described, the computing systems and methods described herein can be coupled to paper cutting devices, paper sorting devices, robotic devices, etc. In some embodiments, a web based system can be used for an end user to select and purchase a desired paper order. The web based system can further include the paper cutting devices, paper sorting devices, robotic devices, etc.

In another embodiment, the paper might be further customized. For example, a web based system might be coupled to printing devices that allow headers, footers, or other custom letter head to be generated and then shipped to the end user. Which might all be done remotely using the web based system. Accordingly, a user might control these devices directly and independently.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed system.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium is coupled to the processor such that the processor can read information from, and write information to, the storage medium. In the alternative, the storage medium may be integral to the processor.

Embodiments of the disclosed system can include a computer readable media embodying a method in accordance with the systems and methods described herein. Accordingly, the disclosed system is not limited to illustrated examples and any means for performing the functionality described herein are included in embodiments of the disclosed system.

While the foregoing disclosure shows illustrative embodiments of the disclosed system, it should be noted that various changes and modifications could be made herein without departing from the scope of the disclosed system. Furthermore, the invention shall be defined only by the appended claims. The functions, steps and/or actions of the claims need not be performed in any particular order. Furthermore, although elements of the invention may be claimed in the singular, the plural is contemplated unless limitation to the singular is explicitly stated.

The skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

What is claimed is:

1. A system for determining the price of paper having a certain specification, the system comprising:
a processor; and
a memory coupled with the processor and including instruction for configuring the processor to:
establish a database in memory;
store a specification concerning a plurality of available paper characteristics in the database, the stored information including information regarding a plurality of features associated with each paper characteristic;
receive a request for quote for a specified paper requirement, the specified paper requirement being at least one of the plurality of available paper characteristics in the database wherein selected paper type is input, a width and a length of the selected paper type are multiplied and result in an MWT value whereby a fourth input is multiplied to determine a total weight;
present a plurality of search results of a plurality of available paper types having the specified paper requirement;
generate a price quote for each available paper type in the plurality of search results, the price quote calculated based on the group comprising a paper type, paper width, paper length, and number of sheets; and
a paper cutter coupled to the processor and wherein the memory further includes instructions causing the processor to: process an order based on the quote; and send signals to the paper cutter for cutting the paper based on a selection of paper characteristics from the plurality of available paper characteristics in the database.

2. The system of claim 1, further comprising a paper sorting machine coupled to the processor and wherein the memory further includes instructions causing the processor to:
process an order based on the quote; and
send signals to the paper sorting machine causing the paper sorting machine to select the paper for the order.

3. The system of claim 1, wherein a specification of the paper used to generate the.

4. The system of claim 3, wherein the predefined pricing rule adjusts the calculation of the price quote based on the specification.

5. The system of claim 1, wherein the predefined pricing rule adjusts the calculation of the price quote based on information specific to the paper type.

6. The system of claim 1, wherein the predefined pricing rule is further associated with a specified paper weight.

7. The system of claim 1, further comprising a plurality of graphical tools to facilitate interfaces between an internet user and the online e-commerce site is provided.

8. A computerized method for determining the price of paper having a certain specification, the method comprising:
establishing a database in a memory, wherein a plurality of components of the database and the memory are implemented in at least one of an electronic circuit and software coding, wherein a plurality of components implemented in the software coding are stored in an executable format on a non-transitory machine-readable medium;
storing information concerning a plurality of available paper characteristics in the database, the stored information including information regarding a plurality of features associated with each paper characteristic;
receiving a request for quote for a specified paper requirement, the specified paper requirement being at least one of the plurality of available paper characteristics in the database;
receiving a request for quote for a specified paper requirement, the specified paper requirement being at least one of the plurality of available paper characteristics in the database wherein selected paper type is input, a width and a length of the selected paper type are multiplied and result in an MWT value whereby a fourth input is multiplied to determine a total weight;
presenting a plurality of search results of a plurality of available paper types having the specified paper requirement;
generating a price quote for each available paper type in the plurality of search results, the price quote calculated based on a predefined pricing rule associated with a paper type; and
a paper cutter coupled to the processor and wherein the memory further includes instructions causing the processor to: process an order based on the quote; and send signals to the paper cutter for cutting the paper based on a selection of paper characteristics from the plurality of available paper characteristics in the database.

9. The method of claim 8, further comprising sending signals to a paper sorting machine causing the paper sorting machine to select the paper for the order.

10. The method of claim 8, further comprising:
processing an order based on the quote; and
sending signals to a paper cutter for cutting the paper based on a selection of paper characteristics from the plurality of available paper characteristics in the database.

11. The method of claim 8, further comprising using the predefined pricing rule to adjust the calculation of the price quote based on the specification.

12. The method of claim 8, further comprising using the predefined pricing rule to adjusts the calculation of the price quote based on information specific to the paper type.

13. The method of claim 11, further comprising using a plurality of graphical tools to facilitate interfaces between an internet user and the online e-commerce site is provided.

14. The method of claim 11, further comprising instructions causing the processor to multiply a width and a length of the selected paper type, wherein a MWT value is derived, and whereby a fourth input is multiplied to determine a total weight; and wherein, after determining total weight, a price break is obtained from the database and the final price is calculated.
